(19) United States
(12) Patent Application Publication
(10) Pub. No.: US 2006/0199094 A1
(43) Pub. Date: Sep. 7, 2006

(54) Carrier and developer compositions

(75) Inventors: Michael L. Grande, Palmyra, NY (US); William H. Hollenbaugh JR., Rochester, NY (US); Susan J. Lafica, Fairport, NY (US); Richard N. Muller, Canandaigua, NY (US); Robert Jiles, Rochester, NY (US); James R. Paxson, Newnan, GA (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/074,090

(22) Filed: Mar. 7, 2005

(51) Int. Cl. G03G 9/113

(52) U.S. Cl. 430/111.32; 430/111.35; 430/111.31; 430/111.41

(57) ABSTRACT

A developer composition comprising a magnetic toner and a mixture comprised of bare carrier core particles free of a coating and coated carrier particles, and wherein said bare carrier core particles are present in an amount of from about 50 weight percent to about 90 weight percent, and said coated carrier particles are present in an amount of from about 50 weight percent to about 90 weight percent, and wherein the total thereof is about 100 percent.

### CROSS-REFERENCE TO RELATED APPLICATIONS

Illustrated in U.S. Pat. No. 6,511,780, the disclosure of which is totally incorporated herein by reference, are, for example, carrier particles comprised of a mixture of insulating carrier particles and conductive carrier particles.

Illustrated in U.S. Pat. No. 6,528,225, the disclosure of which is totally incorporated herein by reference, is carrier comprised of a core, a number of the pores thereof containing a polymer, and thereover a coating.

Illustrated U.S. Pat. No. 6,358,659, the disclosure of which is totally incorporated herein by reference, is, for example, a carrier comprised of a core and thereover a polymer, and wherein the polymer contains a conductive polymer dispersed therein.

Illustrated in U.S. Pat. No. 6,391,509, the disclosure of which is totally incorporated herein by reference, is, for example, a carrier comprised of a core, a polymer coating, and wherein the coating contains a conductive polymer.

Toners containing a number of magnetites are illustrated, for example, in U.S. Pat. No. 6,767,684, which discloses a toner process comprising mixing a colorant dispersion comprising an acicular magnetite dispersion and a colorant with a latex containing a crosslinked resin, a latex containing a resin free of crosslinking, a wax dispersion, a resin, and a coagulant; and in U.S. application Ser. No. 10/606,330, filed Jun. 25, 2003, which discloses a toner process comprised of heating a mixture of an acicular magnetite dispersion, a colorant dispersion, a wax dispersion, a first latex containing a crosslinked resin, and a second latex containing a resin free of crosslinking in the presence of a coagulant to provide aggregates, stabilizing the aggregates with a silicate salt dissolved in a base, and further heating said aggregates to provide coalesced toner particles, the disclosure of each application being totally incorporated herein by reference.

The appropriate components, processes and the like of the copending applications may be selected for the present disclosure in embodiments thereof.

### BACKGROUND

This disclosure is generally directed to developer compositions, and more specifically, the present disclosure relates to developer compositions containing a carrier mixture. In embodiments of the present disclosure the carrier particles are comprised of a mixture of a first carrier comprised, for example, of an uncoated core, that is a carrier core free of a coating thereover referred to as a bare carrier core, such as an iron powder core available from Hoeganaes Inc. of Canada, and which core can be referred to as an atomized steel powder, including a rough core and a second carrier comprised of a coated core wherein the coating can be a polymer or mixture of polymers, and in embodiments wherein each of the cores can be of a similar size diameter and a magnetic toner comprised, for example, of a polymer, colorant, and a magnetite. In embodiments of the present disclosure the bare carrier core is present in an amount of at least about 50 percent by weight, and more specifically, from about 50 percent by weight to about 90 percent by weight, and yet more specifically, from about 55 to about 75 percent by weight and the second coated core is present in an amount of at least about 50 percent by weight, and more specifically, from about 50 percent by weight to about 90 percent by weight, and yet more specifically, from about 55 to about 75 percent by weight, and wherein the total amount of the first bare core and the second coated core is about 100 percent. One specific carrier mixture is comprised of about 50 percent of the first bare core and about 50 percent of the second coated core. In embodiments of the present disclosure, the developer composition may be prepared by adding the bare carrier core particles and coated carrier particles to the magnetite toner particles.

The carrier mixture enables excellent conductivity characteristics, such as a conductivity of at least from about 10⁻⁸ to about 10⁻⁷ S/cm, and more specifically, wherein the conductivity of the carrier mixture and the developer is improved by a factor of about 1,000 as compared to the conductivity of the carrier mixture of U.S. Pat. No. 5,336,579, the disclosure of which is totally incorporated herein by reference, and which conductivities can be measured by known methods, such as determined in a magnetic brush cell at 10 volts. Further advantages associated with the carriers and developers of the present disclosure include, for example, excellent optical density increases of the obtained solid image by approximately the same factor as the DMA developability characteristics of developers within which it is contained, and permits improvements in development stability in low throughput aging (for example, prolonged, such as for 100 cycles, and more specifically from about 100 to about 1,000 cycles, at a low, about for example 5 weight percent area coverage corresponding to a full page of text. Conductivity of a developer of carrier and toner in a donor-roll development system is preferably maintained at least about 10⁻⁶ to about 10⁻⁹ S/cm or higher to provide sufficient toner reload on the donor roll. Deficient reload appears upon printing large solid area images as fading of the solid or half-tone area after one full revolution of the donor roll. Typically, an increase of lightness (L*) by 3 or less is permitted in reloaded solid area. Changes of L* by greater than 3 are visible to a naked eye, and thus constitute a print defect. Moreover, the carrier mixtures in embodiments of the present disclosure enable the controlling and preselection of the triboelectric charge and conductivity of the carrier, the formation of homogenous mixtures, excellent carrier coating adherence, stable charging characteristics, carrier design flexibility and freedom, economical carrier formation, increased developability, development stability to low throughput aging, developer conductivity at high levels of about 10⁻¹⁰ to about 10⁻⁸, excellent stable charging characteristics, and the like.

The carrier mixture of the present disclosure may be mixed with a magnetite or magnetic toner of resin, colorant, and optional toner additives, and more specifically, toners generated by known emulsion/aggregation processes, and wherein the toner volume average diameter can vary; for example, the diameter can be from about 2 to about 25 microns, and more specifically, from about 4 to about 7 microns, and yet more specifically, from about 5 to about 6 microns to provide developers that can be selected for the development of images in electrostatographic, especially xerographic, imaging systems, printing processes, digital systems, more specifically hybrid development, reference for example U.S. Pat. No. 5,032,872, the disclosure of which is totally incorporated herein by reference.

Examples of carriers in embodiments of the present disclosure include those comprised of a suitable carrier bare or uncoated, that is for example, a carrier core free of a coating thereover, carrier core as illustrated herein, and a second carrier comprised of a core and a polymer thereover, such as polymethylmethacrylate (PMMA), polyvinylidenefluoride, polyethylene, copolyethylene vinylacetate, copolyvinylidenefluoride tetrafluoroethylene, polystyrene, polytetrafluoroethylene, polyvinylchloride, polyvinylfiuoride, polylbutylacrylate, copolybutylacrylate methacrylate, polytrifluoroethylmethacrylate, polyurethanes, and mixtures thereof, especially a mixture of two polymers; and a second carrier comprised of a core, a polymer thereover and a conductive component, such as a conductive carbon black dispersed in the polymer coating.

Processes of imaging, especially xerographic imaging and printing, including MICR and digital, are also encompassed by the present disclosure. More specifically, the developers of the present disclosure can be selected for a number of different known imaging and printing processes including, for example, electrophotographic imaging processes, especially xerographic imaging and printing processes wherein charged latent images are rendered visible with toner compositions of an appropriate charge polarity; color xerographic applications, particularly high-speed color copying and printing processes, and preferably MICR, that is magnetic imaging processes, and wherein the toner contains a magnetic component.

### REFERENCES

Carriers with a coating of a conductive polymethylmethacrylate (PMMA) and insulating PMMA are illustrated in U.S. Pat. No. 5,518,855; carriers containing a mixture of polymers, especially two polymers not in close proximity in the triboelectric series are illustrated in U.S. Pat. No. 5,015,550, the disclosure of which is totally incorporated herein by reference. The appropriate components, such as the polymer coatings and processes of the U.S. Pat. No. 5,015,550 patent, can be selected for the present disclosure in embodiments thereof.

In U.S. Pat. No. 5,998,076, the disclosure of which is totally incorporated herein by reference, is disclosed carrier comprised of a hard magnetic core, the pores thereof containing polymer, and thereover a coating.

Illustrated in U.S. Pat. No. 6,004,712, the disclosure of which is totally incorporated herein by reference, are carriers, coated carriers, and developers thereof.

In U.S. Pat. No. 5,336,579, the disclosure of which is totally incorporated herein by reference, is disclosed, for example, a developer composition comprising color toner particles, bare carrier core particles and coated carrier particles, wherein the color toner particles comprise red colorant particles, blue colorant particles, or green colorant particles, wherein the bare carrier core particles are present in an amount ranging from about 10 weight percent to about 40 weight percent by weight for the developer composition comprised of the blue colorant particles or the red colorant particles, and wherein the bare carrier core particles are present in an amount ranging from about 10 weight percent to about 20 weight percent by weight for the developer composition comprised of the green colorant particles based on the total weight of the bare carrier core particles and the coated carrier particles.

Developer compositions with coated carriers that contain conductive components like carbon black are known. Disadvantages associated with these carriers may be that the carbon black can increase the brittleness of the polymer matrix, which causes the separation of the coating from the core, and thereby contaminates the toner and developer causing, for example, instabilities in the charging level of the developer as a function of a number of factors, such as the developer age in the xerographic housing and the average toner area coverage of a printed page, or instabilities in the color gamut of the developer set. In addition, with carbon black it is difficult to tune, or preselect the carrier conductivity. These and other disadvantages are avoided, or minimized with the carriers of the present disclosure in embodiments thereof.

The conductivity of carbon blacks is generally independent of the type of carbon black used, and in carbon black composites there is usually formed a filamentary network above a certain concentration, referred to as the “percolation” threshold. At concentrations of up to about 30 weight percent, conductivities of 10⁻² (ohm-cm)⁻¹ have been reported. The resistivity thereof, measured with a standard 4-pin method, according to ASTM-257, is observed to increase with decreasing carbon black concentration.

Carrier particles for use in the development of electrostatic latent images are illustrated in many patents including, for example, U.S. Pat. No. 3,590,000. These carrier particles may contain various cores, including steel, with a coating thereover of fluoropolymers, or terpolymers of styrene, methacrylate, and silane compounds. A disadvantage encountered with some prior art carrier coatings resides in fluctuating triboelectric charging characteristics, particularly with changes in relative humidity. The aforementioned modifications in triboelectric charging characteristics provides developed images of lower quality, and with background deposits.

There are illustrated in U.S. Pat. No. 4,233,387, the disclosure of which is totally incorporated herein by reference, coated carrier components for electrostatographic developer mixtures comprised of finely divided toner particles clinging to the surface of the carrier particles. Specifically, there is disclosed in this patent coated carrier particles obtained by mixing carrier core particles of an average diameter of from between about 30 microns to about 1,000 microns with from about 0.05 percent to about 3 percent by weight, based on the weight of the coated carrier particles, of thermoplastic resin particles. The resulting mixture is then dry blended until the thermoplastic resin particles adhere to the carrier core by mechanical impaction, and/or electrostatic attraction. Thereafter, the mixture is heated to a temperature of from about 320° F. to about 650° F. for a period of 20 minutes to about 120 minutes, enabling the thermoplastic resin particles to melt and fuse on the carrier core. While the developer and carrier particles prepared in accordance with the process of this patent are suitable for their intended purposes, the conductivity values of the resulting particles are not believed to be constant in all instances, for example, when a change in carrier coating weight is accomplished to achieve a modification of the triboelectric charging characteristics; and further with regard to the '387 patent, in many situations carrier and developer mixtures with only specific triboelectric charging values can be generated when certain conductivity values or characteristics are contemplated. With the disclosure of the present application, in embodiments thereof the conductivity of the resulting carrier particles are substantially higher and constant, and moreover the triboelectric values can be selected to vary significantly, for example, from less than about 80 microcoulombs per gram to greater than about −80 microcoulombs per gram, depending on the polymer mixture selected for affecting the coating processes.

Carriers obtained by applying insulating resinous coatings to porous metallic carrier cores using solution coating techniques can be undesirable from many viewpoints. For example, insufficient coating material may be present, and therefore, is not as readily available for triboelectric charging when the coated carrier particles are mixed with finely divided toner particles. Attempts to resolve this problem by increasing the carrier coating weights, for example, to 3 percent or greater to provide a more effective triboelectric coating to the carrier particles necessarily involves handling excessive quantities of solvents, and further usually these processes result in low product yields. Also, solution coated carrier particles when combined and mixed with finely divided toner particles provide in some instances triboelectric charging values which are low for many uses. Powder coating processes have been utilized to overcome these disadvantages, and further to enable developer mixtures that are capable of generating high and useful triboelectric charging values with finely divided toner particles; and also wherein the carrier particles are of substantially constant conductivity. Further, when resin coated carrier particles are prepared by the powder coating process, the majority of the coating materials are fused to the carrier surface thereby reducing the number of toner impaction sites on the carrier material.

Powder coating processes typically utilize polymers in the form of fine powders which can be mixed and properly coat the carrier core. The triboelectric charging value of the aforementioned carriers can be controlled by the polymer or mixture of polymers selected for the coating. The disadvantage of this approach is that only a limited number of polymers are available in the form of fine powders, especially for the preparation of conductive carriers. Two approaches are known in the prior art for fabricating conductive carriers. First, conductive polymers which are in the form of fine powder can be utilized, for example, a conductive carbon black loaded polymer, reference U.S. Pat. No. 5,236,629, the disclosure of which is totally incorporated herein by reference. A second approach is to partially coat the carrier core with polymer. However, coatings prepared by this method have the tendency to chip or flake off, and fail upon impact, or abrasive contact with machine parts and other carrier particles. These flakes or chips, which cannot readily be reclaimed from the developer mixture, have an adverse effect on the triboelectric charging characteristics of the carrier particles, thereby providing images with lower resolution in comparison to those compositions wherein the carrier coatings are retained on the surface of the core substrate. Furthermore, partially coated carriers have a short life, for example from about 1 to about 30 days, and poor stability.

Other patents of interest include U.S. Pat. No. 3,939,086, which illustrates steel carrier beads with polyethylene coatings, see column 6; U.S. Pat. No. 4,264,697, which discloses dry coating and fusing processes; U.S. Pat. Nos. 3,533,835; 3,658,500; 3,798,167; 3,918,968; 3,922,382; 4,238,558; 4,310,611; 4,397,935; 5,015,550; 5,002,846; 4,937,166, 4,434,220; 4,513,074 disclosing a developer composition containing uncoated ferrite carrier particles; U.S. Pat. No. 5,100,753 disclosing processes for the preparation of coated carrier particles; U.S. Pat. No. 4,828,956, which discloses processes for maintaining the triboelectric stability of developers; U.S. Pat. No. 4,948,686, which discloses a process for forming two-color images; U.S. Pat. No. 4,678,734, which discloses a process for preparing developer compositions; U.S. Pat. No. 4,935,326, which discloses carrier particles coated with polymer mixture and U.S. Pat. No. 4,937,166, which discloses carrier particles coated with polymer mixture.

Certain ferrite carriers are illustrated in U.S. Pat. Nos. 4,546,060, 4,764,445; 4,855,205, and 4,855,206. In the U.S. Pat. No. 4,855,205 patent there is disclosed a two phase ferrite composite with a spinel or S phase of the formula MFe₂O₄ and a magnetoplumbite or M phase, and which composite and magnetized. It is indicated in column 3 of this patent that the composites can be prepared by conventional procedures and that the composite can be coated with a polymer well known in the art. Examples of polymers include those as illustrated in U.S. Pat. No. 4,546,060, such as fluorocarbon polymers like polytetrafluoroethylene, polyvinylidenefluoride, and the like, see column 8.

Also of interest may be U.S. Pat. Nos. 6,361,915 and 6,355,391 which disclose, for example, emulsion polymerization methods for the preparation of polymethylmethacrylate (PMMA) nano powders which may also contain carbon black.

With respect to the prior art, only a small part thereof has been selected and this part may or may not be fully representative of the prior art teachings or disclosures.

The disclosures of each of the above patents are totally incorporated herein by reference. The appropriate carrier cores and polymer coatings of these patents may be selected for the present disclosure in embodiments thereof.

### SUMMARY

It is a feature of the present disclosure to provide toner and developer compositions with many of the advantages illustrated herein, and wherein the carriers thereof can be generated from a mixture of carriers enabling excellent and high conductivity characteristics, and which carrier mixtures can be selected for known hybrid jumping development (HJD) processes and devices.

In yet another feature of the present disclosure there are provided processes for generating carrier particle mixtures with preselected conductivities and preselected triboelectric charging values.

Yet another feature of the present disclosure is to provide conductive carrier particle mixtures that can be mixed in various proportions to achieve a carrier mixture with a selected desired conductivity.

In yet a further feature of the present disclosure there are provided conductive carrier coatings that can be generated from a monomer or monomers that, for example, are not in close proximity in the triboelectric series, that is for example, a mixture of monomers from different positions in the triboelectric series, and wherein the resulting coating optionally has incorporated therein, or present therein or thereon a conductive component like a conductive carbon black, such as VULCAN™ carbon black available from Cabot Corporation.

In still a further feature of the present disclosure there are provided carrier particles with improved mechanical characteristics, carriers wherein the conductivity thereof is tunable by, for example, adjusting the concentration or amount of coated carriers in the mixture, and carriers wherein the coating adheres to the core and wherein there is minimal or no separation of the polymer coating from the core.

Further, in an additional feature of the present disclosure there are provided carrier particles wherein the carrier triboelectric charging values are from about 25 to about 70 microcoulombs per gram at the same coating weight as determined by the known Faraday Cage technique.

Aspects of the present disclosure relate to a developer composition comprising a magnetic toner and a mixture comprised of bare carrier core particles free of a coating and coated carrier particles, and wherein said bare carrier core particles are present in an amount of from about 50 weight percent to about 90 weight percent, and said coated carrier particles are present in an amount of from about 50 weight percent to about 90 weight percent, and wherein the total thereof is about 100 percent; a carrier composition comprising noncoated carrier core particles and coated carrier core particles, wherein the noncoated carrier core particles are present in an amount of from about 50 weight percent to about 75 weight percent, based on the total weight of the mixture of uncoated and coated carrier particles; a process for increasing the triboelectric charging value Aₜ, and/or conductivity value of a developer composition toner and a mixture of coated and uncoated carrier components wherein the coated carrier component is present in an amount of from about 50 weight percent to about 90 weight percent, and wherein the total of said coated and uncoated carrier is 100 percent, providing that at least one of said carriers is present in an amount of about 50 percent; a xerographic device comprised of a charging component, a photoconductive component, a developer component, a transfer component, and a fixing component, and wherein the developer component contains developer composition comprising a magnetic toner and a mixture comprised of bare carrier core particles free of a coating and coated carrier particles, and wherein said bare carrier core particles are present in an amount of from about 50 weight percent to about 90 weight percent, and said coated carrier particles are present in an amount of from about 50 weight percent to about 90 weight percent, and wherein the total thereof is about 100 percent; carrier compositions comprised of a mixture of bare carrier particles and coated carrier particles; a carrier wherein the mixture is a homogenous mixture; a carrier mixture wherein the coated carrier is coated with a polymer, or a mixture of polymers; a carrier mixture containing a second carrier core and thereover from about 2 polymers to about 7 polymers; a carrier composition comprised of a first bare uncoated carrier with a core of, for example, steel comprised of irregularly shaped particles containing protrusions and dimples with sizes of, for example, from about 1 to about 15 microns for both dimples and protrusions, that is, a rough morphology, and a second coated carrier, and which composition can be mixed with a magnetic toner, including magnetite toners generated by emulsion/aggregation processes, reference U.S. patents such as U.S. Pat. No. 5,290,654, U.S. Pat. No. 5,278,020, U.S. Pat. No. 5,308,734, U.S. Pat. No. 5,370,963, U.S. Pat. No. 5,344,738, U.S. Pat. No. 5,403,693, U.S. Pat. No. 5,418,108, U.S. Pat. No. 5,364,729, and U.S. Pat. No. 5,346,797. Also of interest may be U.S. Pat. Nos. 5,348,832; 5,405,728; 5,366,841; 5,496,676; 5,527,658; 5,585,215; 5,650,255; 5,650,256; 5,501,935; 5,723,253; 5,744,520; 5,763,133; 5,766,818; 5,747,215; 5,827,633; 5,853,944; 5,804,349; 5,840,462; 5,869,215; 5,910,387; 5,919,595; 5,916,725; 5,902,710; 5,863,698, 5,925,488; 5,977,210 and 5,858,601 the disclosures of each of which are totally incorporated herein by reference; a carrier mixture with a conductivity of about 10⁻¹⁰ to about 10⁻⁸ (ohm-cm) ⁻¹; a carrier mixture wherein the first bare carrier has a conductivity of about 10⁻⁵ to about 10⁻⁸ (ohm-cm) ^{-1,} and the resulting carrier mixture possesses a conductivity of about 10⁻⁵ to about 10⁻⁹ (ohm-cm) ⁻¹; a carrier mixture comprised of a bare carrier and a polymer coating of polymethylmethacrylate, polyvinylidenefluoride, polyvinylfluoride, copolybutylacrylate methacrylate, copolyperfluorooctylethyl methacrylate methylmethacrylate, or polystyrene, and optionally wherein the coating contains a conductive filler component; a carrier wherein the conductive component is a conductive carbon black, optionally present in an amount of from about 20 to about 70 weight percent, or wherein the conductive component is a metal oxide, a metal, a conductive polymer, or a semiconductor component; a carrier wherein the polymer is polymethylmethacrylate, and wherein the core is powdered iron; a carrier mixture containing from about 50 to about 75 percent of a bare carrier and from about 50 to about 75 percent of a coated carrier, and wherein the total thereof is about 100 percent, or wherein in the mixture there is present from about 60 to about 80 percent of a bare carrier and from about 40 to about 20 percent of a coated carrier, and wherein the total thereof is about 100 percent; a carrier wherein in the mixture there is present from about 55 to about 75 percent of a bare carrier, such as a steel core, and from about 45 to about 25 percent of a coated carrier core, and wherein the total thereof is about 100 percent, and wherein the coated carrier or carriers contain a core that is coated with a polymer, and wherein the polymer encompasses from about 75 to about 100 percent of the core; a process wherein the monomer to form the polymer carrier coating is selected from the group consisting of acrylic acid, methyl acrylate, ethyl acrylate, n-butyl acrylate, isobutyl acrylate, dodecyl acrylate, n-octyl acrylate, 2-chloroethyl acrylate, phenyl acrylate, methacrylic acids, methyl methacrylate, ethyl methacrylate, butyl methacrylate, octyl methacrylate, acrylonitrile, methacrylonitrile and acrylamide; maleic acid, monobutyl maleate, dibutyl maleate; vinyl chloride, vinyl bromide, vinyl fluoride, vinyl acetate and vinyl benzoate; vinylidene chloride; pentafluoro styrene, allyl pentafluorobenzene, N-vinyl pyrrole, and trifluoroethyl methacrylate; and mixtures thereof; and wherein the monomer is present in an amount of from about 1 to about 5 percent by weight of the carrier core, or wherein the monomer is methyl methacrylate, styrene, trifluoroethyl methacrylate, or mixtures thereof, and wherein the monomer is present in an amount of from about 0.5 to about 10 percent by weight, or from about 1 to about 5 percent by weight of the carrier core, and wherein the initiator for polymerization of the monomer is selected from the group consisting of azo compounds, peroxides, and mixtures thereof, and where the amount of the initiator is from about 0.1 to about 20 percent by weight, or from about 0.5 to about 10 percent by weight of the monomer mixture; a carrier mixture wherein the coated carrier contains a core of a diameter of from about 30 to about 100 microns; a carrier wherein the coating polymer is polyvinylidenefluoride, polyethylene, polymethylmethacrylate, polytrifluoroethylmethacrylate, copolyethylene vinylacetate, copolyvinylidenefluoride, tetrafluoroethylene, polystyrene, tetrafluoroethylene, polyvinyl chloride, polyvinyl acetate, or mixtures thereof, and optionally wherein the coating contains a conductive filler component; a carrier composition wherein each of the core diameters is about 30 to about 100 microns as measured by a Malvern laser diffractometer; a carrier composition wherein the core is iron, steel or a ferrite, such as an iron ferrite, strontium ferrite, and the like; a carrier mixture comprised of a steel core and a coated core, and wherein the polymer coating is present in an amount of from about 0.5 to about 99 percent by weight; and when selected wherein the conductive component is present in an amount of from about 10 to about 70 percent by weight of the polymer coating; wherein the conductive component is present in an amount of from about 20 to about 50 percent by weight of the polymer coating; a process for the preparation of carriers comprising the mixing of a bare or uncoated carrier core and a coated carrier containing a polymer formed from a monomer and initiator, chain transfer agent, followed by polymerizing the monomer by heating thereby resulting in a polymer and drying; a process wherein a monomer mixture is heated at a temperature of from about 50° C. to about 95° C., or from about 60° C. to about 85° C.; a process wherein the monomer mixture is heated for a period of from about 30 minutes to about 5 hours, or from about 30 minutes to about 3 hours; a process wherein the monomer is selected from the group consisting of styrene, α-methyl styrene, p-chlorostyrene, monocarboxylic acids and the derivatives thereof; dicarboxylic acids with a double bond and derivatives thereof; vinyl ketones; vinyl naphthalene; unsaturated mono-olefins; vinylidene halides; N-vinyl compounds; fluorinated vinyl compounds; and mixtures thereof; a process wherein the monomer is selected from the group consisting of acrylic acid, methyl acrylate, ethyl acrylate, n-butyl acrylate, isobutyl acrylate, dodecyl acrylate, n-octyl acrylate, 2-chloroethyl acrylate, phenyl acrylate, methylalpha chloracrylate, methacrylic acids, methyl methacrylate, ethyl methacrylate, butyl methacrylate, octyl methacrylate, acrylonitrile, methacrylonitrile and acrylamide; maleic acid, monobutyl maleate, dibutyl maleate; vinyl chloride, vinyl bromide, vinyl fluoride, vinyl acetate and vinyl benzoate; vinylidene chloride; pentafluoro styrene, allyl pentafluorobenzene, N-vinyl pyrrole, trifluoroethyl methacrylate, and mixtures thereof; a process wherein the monomer is methyl methacrylate, styrene, trifluoroethyl methacrylate, or mixtures thereof, wherein the conductive additive is a carbon black, and where the amount of the conductive additive present is from about 10 to about 70 percent by weight, or from about 20 to about 50 percent by weight; a process wherein the initiator is selected from the group consisting of azo compounds, peroxides, and mixtures thereof, and where the amount of the initiator is from about 0.1 to about 20 percent by weight, or from about 0.5 to about 10 percent by weight of the monomer mixture; a process wherein the initiator is selected from the group consisting of 2,2′-azodimethylvaleronitrile, 2,2′-azoisobutyronitrile, azobiscyclohexanenitrile, 2-methylbutyronitrile, benzoyl peroxides, lauryl peroxide, 1-1-(t-butylperoxy)-3,3,5-trimethylcyclohexane, n-butyl-4,4-di-(t-butylperoxy)valerate, dicumyl peroxide, and mixtures thereof; a process wherein the chain transfer agent is selected from the group consisting of mercaptans and halogenated hydrocarbons, and wherein the chain transfer agent is selected in an amount of from about 0.01 to about 1 percent by weight, or from about 0.05 to about 0.5 percent by weight of the monomer mixture; and a process wherein the chain transfer agent is selected from the group consisting of laurylmercaptan, butylmercaptan carbon tetrachloride, carbon tetrabromide and mixtures thereof; and a developer comprised of a conductive carrier mixture and toner.

The core of the coated carrier particles and the bare carrier core particles may be comprised of the same or a different material. Illustrative examples of suitable carrier core particles include granular zircon, steel, nickel, iron, ferrites like Cu/Zn/Ni ferrite; alloys of iron such as iron-silicon, iron-aluminum-silicon, iron-nickel, iron-cobalt, and mixtures thereof; ferrites include a class of magnetic oxides that contain iron as the major metallic component, and optionally a second metallic component including magnesium, manganese, cobalt, nickel, zinc, copper, and mixtures thereof. Other suitable carrier particles include nickel berry carriers as disclosed in U.S. Pat. No. 3,847,604, the disclosure of which is totally incorporated herein by reference. More specifically, the core of the coated carrier particles and the bare carrier core particles are comprised of Hoeganaes Anchor Steel Core, available from Hoeganaes Corp. or a Toniolo Steel Core, available from Metallurgica Toniolo S.p.A., Maerne, Italy, both optionally unoxidized, iron, iron alloys, steel, ferrites, magnetites, nickel, and mixtures thereof. As indicated herein any suitable coating material may be used to coat the selected core particles resulting in the coated carrier particles. Examples of suitable coating materials include resins such as polystyrene, homopolymers, copolymers, and terpolymers; polymers of halogen containing ethylenes including vinyl fluorides, vinylidene fluorides, vinyl chlorides, vinylidene chlorides, chlorotrifluoroethylene, a vinyl chloride/chlorotrifluoroethylene copolymer, a vinyl chloride/vinyl acetate copolymer, a chlorotrifluoroethylene polymer, and various known vinyl chloride terpolymers. Acrylic polymers and copolymers typified by polymethylmethacrylate and siloxane polymers are also useful carrier coatings, particularly when negative charging toners are desired. Preferably, carrier coatings are present in an amount of from about 0.1 to about 1 percent by weight of the uncoated carrier particle, although other amounts are suitable provided that the objectives of the present disclosure are achieved. Coated and bare carrier particles generally may have a diameter of, for example, from about 25 to about 1,000 microns, and preferably about 40 to about 150 microns, thus allowing these particles to possess sufficient density and inertia to avoid adherence to the electrostatic image during the development process. Many of the typical carriers that can be used are described in U.S. Pat. Nos. 2,618,441; 2,638,522; 3,533,835; 3,526,533; 3,590,000; 3,847,604; 3,767,598; 4,233,387; 4,935,326, and 4,937,166, the disclosures of which are totally incorporated by reference.

Coating of the carrier particles may be by any suitable process, such as powder coating as illustrated herein, wherein a dry powder of the coating material is applied to the surface of the carrier particle and fused to the core by means of heat; solution coating wherein the coating material is dissolved in a solvent and the resulting solution is applied to the carrier surface by tumbling; or fluid bed coating in which the carrier particles are blown into the air by means of an air stream, and an atomized solution comprising the coating material and a solvent is sprayed onto the airborne carrier particles repeatedly until the desired coating weight is achieved.

There results, in accordance with aspects of the present disclosure, carrier particles of relatively constant conductivities, measured by the 2-probe current-voltage DC method of from, for example, about 10⁻¹⁵ to about 10⁻² (ohm-cm)⁻¹, about 10⁻¹⁰ to about 10⁻⁷ (ohm-cm)⁻¹, for example, a voltage of about 10 volts, applied to a magnetic brush formed on a magnetic roller containing approximately 30 to 100 grams of carrier with a gap between electrodes of ˜0.1 centimeter, and wherein the carrier particles are of a triboelectric charging value of from about −80 to about 80 microcoulombs per gram, and more specifically, from about −60 to about 60 microcoulombs per gram as determined by a Faraday Cage, or in embodiments a developer conductivity improvement of 1,000 as compared, for example, to the developers of U.S. Pat. No. 5,336,579; these parameters being dependent on the carrier coatings selected, and the percentage of each of the polymers used, and the conductive polymer.

Toners can be admixed with the carrier to generate developers. As one toner resin there can be selected the esterification products of a dicarboxylic acid and a diol comprising a diphenol, reference U.S. Pat. No. 3,590,000, the disclosure of which is totally incorporated herein by reference, reactive extruded polyesters, such as those illustrated in U.S. Pat. No. 5,227,460, the disclosure of which is totally incorporated herein by reference, and the like. Specific toner resins include styrene/methacrylate copolymers; styrene/butadiene copolymers; polyester resins obtained from the reaction of bisphenol A and propylene oxide; and branched polyester resins resulting from the reaction of dimethylterephthalate, 1,3-butanediol, 1,2-propanediol and pentaerythritol. Other toner resins are illustrated in a number of U.S. patents including some of the patents recited hereinbefore.

Generally, from about 1 part to about 5 parts by weight of toner are mixed with from about 10 to about 300 parts by weight of the carrier particles.

Numerous well known suitable colorants, such as pigments or dyes, can be selected as the colorant for the toner including, for example, cyan, magenta, yellow, red, blue, carbon black, nigrosine dye, lamp black, iron oxides, magnetites, and mixtures thereof. The colorant, which can be carbon black, should be present in a sufficient amount to render the toner composition highly colored. Thus, the colorant particles can be present in amounts of from about 3 percent by weight to about 20 percent by weight, and more specifically, from about 3 percent by weight to about 12 weight percent or percent by weight, based on the total weight of the toner composition; however, lesser or greater amounts of colorant particles can be selected. Colorant includes pigment, dye, mixtures thereof, mixtures of pigments, mixtures of dyes, and the like.

When the colorant particles are comprised of magnetites, the preferred colorant, which are a mixture of iron oxides (FeO.Fe₂O₃) including those commercially available as MAPICO BLACK®, they are usually present in the toner composition in an amount of from about 10 percent by weight to about 70 percent by weight, and preferably in an amount of from about 20 percent by weight to about 50 percent by weight.

The resin particles are present in a sufficient, but effective amount, thus when 10 percent by weight of pigment, or colorant, such as carbon black, is contained therein, about 90 percent by weight of resin is selected. Generally, the toner composition is comprised of from about 85 percent to about 97 percent by weight of toner resin particles, and from about 3 percent by weight to about 15 percent by weight of colorant particles.

The developer compositions can be comprised of thermoplastic resin particles, the carrier mixture illustrated herein, and as colorants magenta, cyan and/or yellow particles, and mixtures thereof. More specifically, illustrative examples of magentas include 1,9-dimethyl-substituted quinacridone and anthraquinone dye identified in the Color Index as CI 60720, CI Dispersed Red 15, a diazo dye identified in the Color Index as CI 26050, CI Solvent Red 19, and the like. Examples of cyans include copper tetra-4(octaecyl sulfonamido) phthalocyanine, X-copper phthalocyanine pigment listed in the Color Index as CI 74160, CI Pigment Blue, and Anthrathrene Blue, identified in the Color Index as CI 69810, Special Blue X-2137, and the like; while illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33, 2,5-dimethoxy-4-sulfonanilide phenylazo-4′-chloro-2,5-dimethoxy aceto-acetanilide, Permanent Yellow FGL, and the like. The colorants, which include pigments, mixtures of pigments, dyes, mixtures of dyes, mixtures of dyes and pigments, and the like, are generally present in the toner composition in an amount of from about 1 weight percent to about 15 weight percent based on the weight of the toner resin particles.

For further enhancing the positive charging characteristics of the developer compositions illustrated herein, and as optional components there can be incorporated therein known charge enhancing additives inclusive of alkyl pyridinium halides, reference U.S. Pat. No. 4,298,672, the disclosure of which is totally incorporated herein by reference; organic sulfate or sulfonate compositions, reference U.S. Pat. No. 4,338,390, the disclosure of which is totally incorporated herein by reference; distearyl dimethyl ammonium sulfate; metal complexes, E-88™, naphthalene sulfonates, quaternary ammonium compounds, and other similar known charge enhancing additives. These additives are usually incorporated into the toner or carrier coating in an amount of from about 0.1 percent by weight to about 20 percent by weight, and preferably from about 1 percent by weight to about 7 weight percent by weight.

Examples of imaging members selected for the imaging processes illustrated herein are selenium, selenium alloys, and selenium or selenium alloys containing therein additives or dopants such as halogens. Furthermore, there may be selected organic photoreceptors, illustrative examples of which include layered photoresponsive devices comprised of transport layers and photogenerating layers, reference U.S. Pat. Nos. 4,265,990; 4,585,884; 4,584,253, and 4,563,406, the disclosures of which are totally incorporated herein by reference, and other similar layered photoresponsive devices. Examples of generating layers are trigonal selenium, metal phthalocyanines, perylenes, titanyl phthalocyanines, metal free phthalocyanines, hydroxygallium phthalocyanines, and vanadyl phthalocyanines. As charge transport molecules there can be selected, for example, the aryl diamines disclosed in the '990 patent. Also, there can be selected as photogenerating pigments, squaraine compounds, thiapyrillium materials hydroxy gallium phthalocyanine, and the like. These layered members are conventionally charged negatively thus usually requiring a positively charged toner.

Moreover, the developer compositions of the present disclosure are particularly useful in electrostatographic magnetic imaging processes and apparatuses wherein there is selected a moving transporting means and a moving charging means; and wherein there is selected a deflected flexible layered imaging member, reference U.S. Pat. Nos. 4,394,429 and 4,368,970, the disclosures of which are totally incorporated herein by reference, and color, other than black, imaging and digital systems, and processors. Images obtained with the developer composition of the present disclosure in embodiments possessed acceptable solids, excellent halftones and desirable line resolution, with acceptable or substantially no background deposits.

The following Examples are being provided to further illustrate the present disclosure, it being noted that these Examples are intended to illustrate and not limit the scope of the present disclosure. Parts and percentages are by weight unless otherwise indicated.

### EXAMPLE I

There was prepared developers by mixing 50 weight percent of a coated carrier and 50 weight percent of an uncoated carrier core; 30 weight percent of a coated carrier and 80 weight percent of a bare carrier core; 25 weight percent of a coated carrier and 75 weight percent of a bare carrier core; and 30 weight percent of a coated carrier and 70 weight percent of an uncoated or bare carrier core with each carrier mixture containing 55 weight percent of styrene methacrylate and 45 percent of magnetite. The bare uncoated carrier core was comprised of an unoxidized Hoeganaes steel core having a diameter of 131 microns as determined by the known sieve measurement; and the coated carrier was comprised of unoxidized Hoeganaes steel core having a diameter of 131 microns as determined by the known sieve measurement and a coating thereover of polymethylmethacrylate (PMMA).

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A developer composition comprising a magnetic toner and a mixture comprised of bare carrier core particles free of a coating and coated carrier particles, and wherein said bare carrier core particles are present in an amount of from about 50 weight percent to about 90 weight percent, and said coated carrier particles are present in an amount of from about 50 weight percent to about 90 weight percent, and wherein the total thereof is about 100 percent.

2. A developer in accordance with claim 1 wherein said bare carrier core particles are present in an amount of from about 50 weight percent to about 75 weight percent, and said coated carrier particles are present in an amount of from about 50 weight percent to about 75 weight percent, and wherein the total thereof is about 100 percent.

3. A developer in accordance with claim 1 wherein said bare carrier core particles are present in an amount of from about 50 weight percent to about 75 weight percent, and said coated carrier particles are present in an amount of from about 50 weight percent to about 25 weight percent, and wherein the total thereof is about 100 percent.

4. A developer in accordance with claim 1 wherein said bare carrier core particles are present in an amount of about 50 weight percent, and said coated carrier particles are present in an amount of about 50 weight percent.

5. The developer in accordance with claim 1 wherein said magnetite is an iron oxide.

6. A developer in accordance with claim 1 wherein said magnetite is an iron oxide present in an amount of from about 35 percent by weight to about 75 percent by weight.

7. A developer in accordance with claim 1 wherein said magnetite is an iron oxide present in an amount of from about 40 percent by weight to about 65 percent by weight, or wherein said magnetite is from about 40 percent by weight to about 55 percent by weight.

8. A developer in accordance with claim 1 wherein said magnetite is comprised of Fe₂O₃:Fe₃O₄.

9. A developer in accordance with claim 1 wherein said magnetite is black in color, and wherein said bare carrier core is comprised of steel particles, optionally unoxidized.

10. A developer in accordance with claim 1 wherein the bare carrier core particles are comprised of a Hoeganaes Anchor Steel Core or Toniolo Steel Core.

11. A developer in accordance with claim 1 wherein the toner is present in an amount from about 0.5 weight percent to about 8 weight percent based on the total weight of the bare carrier core particles and the coated carrier particles.

12. A developer in accordance with claim 1 wherein the core material of the coated carrier particles and the bare carrier core particles are similar, or wherein the core material of the coated carrier particles and the bare carrier core particles are dissimilar.

13. A developer in accordance with claim 1 wherein the core material of the coated carrier particles and the bare carrier core particles are ferrite, iron, or nickel.

14. A developer in accordance with claim 1 wherein the conductivity of said developer increases by a factor of from about 100 to about 1,000 in mho(cm)⁻¹ as compared to developer with one of an uncoated carrier core or a coated carrier core.

15. A developer in accordance with claim 1 wherein the conductivity of said developer increases by a factor of from about 200 to about 700 in mho(cm)⁻¹ as compared to developer with only one of an uncoated carrier core or a coated carrier core, wherein the conductivity of said developer increases by a factor of from about 400 to about 800 in mho(cm)⁻¹ as compared to developer with only one of an uncoated carrier core or a coated carrier core, or wherein the conductivity of said developer increases by a factor of about 1,000 in mho(cm)⁻¹ as compared to developer with only one of an uncoated carrier core or a coated carrier core.

16. A developer in accordance with claim 1 with a conductivity of from about 10⁻³ to about 10⁻⁷ S/cm.

17. A developer in accordance with claim 1 with a conductivity of from about 10⁻² to about 10⁻⁸ S/cm.

18. A developer in accordance with claim 1 wherein the toner comprises a toner resin selected from the group consisting of styrene acrylate, styrene methylmethacrylate, styrene butadiene, and a polyester.

19. A developer in accordance with claim 1 wherein said coating is an acrylic polymer.

20. A developer in accordance with claim 1 wherein said coating is polymethyl methacrylate and carbon black.

21. A carrier composition comprising noncoated carrier core particles and coated carrier core particles, wherein the noncoated carrier core particles are present in an amount of from about 50 weight percent to about 75 weight percent, based on the total weight of the mixture of uncoated and coated carrier particles.

22. A process for increasing the triboelectric charging value Aₜ, and/or conductivity value of a developer composition toner and a mixture of coated and uncoated carrier components wherein the coated carrier component is present in an amount of from about 50 weight percent to about 90 weight percent, and wherein the total of said coated and uncoated carrier is 100 percent, providing that at least one of said carriers is present in an amount of about 50 percent.

23. A process in accordance with claim 22 wherein there results an increase in the magnitude of the triboelectric charging value Aₜ by about 600 or less (10⁻² microcoulombs per gram), and an increase in the conductivity values by about a factor of 10 mho(cm)⁻¹; wherein the coating is comprised of from 1 polymer to about 4 polymers, and wherein said magnetite is iron oxide, a ferrite or a hematite.

24. A developer in accordance with claim 1 wherein said first carrier and said second carrier are of the same or similar size, and optionally wherein said first bare carrier is of a size diameter of from about 50 to about 80 microns, and said second carrier is of a size diameter of from about 50 to about 80 microns.

25. A developer in accordance with claim 1 wherein said carrier mixture possesses a conductivity of at least about 10⁻⁷ to about 10⁻⁹ (ohm-cm)⁻¹.

26. A developer in accordance with claim 1 wherein said carrier mixture possesses a conductivity of higher than about 10⁻⁵ to about 10⁷ (ohm-cm)⁻¹, wherein said coating polymer weight is from about 1 weight percent to about 4 weight percent, or wherein said coating polymer weight is from about 0.05 weight percent to about 2 weight percent.

27. A developer in accordance with claim 2 wherein said coating is a polymer of polymethylmethacrylate, polyvinylidenefluoride, polyvinylfluoride, copolybutylacrylate methacrylate, copolyperfluorooctylethyl methacrylate methylmethacrylate, or polystyrene, or optionally where said coating is a polymer containing dispersed therein a conductive component.

28. A developer in accordance with claim 27 wherein said conductive component is a conductive carbon black present in an amount of from about 20 to about 70 weight percent, or wherein said conductive component is a metal oxide, a metal, or a conductive polymer.

29. A xerographic device comprised of a charging component, a photoconductive component, a developer component, a transfer component, and a fixing component, and wherein the developer component contains the developer of claim 1.
